(19) United States
(12) Patent Application Publication
(10) Pub. No.: US 2007/0113182 A1
(43) Pub. Date: May 17, 2007

(54) Replay of media stream from a prior change location

(75) Inventor: Gerard Hollemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Ba Eindhoven (NL)

(21) Appl. No.: 10/586,937

(22) PCT Filed: Jan. 24, 2005
(86) PCT No.: PCT/IB05/50273

§ 371 Date: Jul. 24, 2006

Related U.S. Application Data
(60) Provisional application No. 60/539,305, filed on Jan. 26, 2004.

(51) Int. Cl. G11B 27/00; H04N 5/44

(52) U.S. Cl. 715/723; 715/716

(57) ABSTRACT

A playback option that the user can engage causes the video stream (30) to move backward to the previous change points (L_{N}-L₁) of the video stream (30) in sequence, and then play the video stream (30) forward from one of the prior change points selected by the user. The change points of a video stream (30) that occur prior to the current play point (T) of the video stream (30) are generated in real time or included in the video stream (30). The change points (L_{N}-L₁) can be speech breaks, shot cuts and movement of persons or objects in the video stream (30).

The invention generally relates to searching of video content. More particularly, the invention relates to searching and playback of a prior portion of a video stream.

There are known methods of video replay. However, these replay techniques are limited. For some systems, a user may enter a specific time stamp from which to begin re-play of the video stream. If a user does not know the particular time point in the video stream from which he or she is interested in playing back, then the best that can be entered is an approximation. This can place the user at a location in the video stream that is before or after the location of interest, thus confusing or frustrating the user. It can also begin the replay in the middle of a sentence, again frustrating or confusing the user. The confusion of the user can be aggravated for those systems that do not render the video stream in reverse when returning to the prior location, since such a reverse rendering can provide the user with a visual context of the re-start location.

Another video replay feature allows the user to initiate a reverse function, for example, via a remote. The play position moves back in time through the video stream until the user disengages the reverse function (for example, by pressing “stop” on the remote). Often such a reverse feature renders the video content in reverse to the user, which provides the user with some general sense of how far he or she has moved backward in the video stream. (Such a reverse function is well-known to users of VCRs, who can re-wind the tape and watch it play in reverse until they arrive at the approximate prior position they are interested in.) However, the reverse function is a crude control and often the user cannot identify the precise location of interest in the video stream, or stop the reverse function at the location of interest. In addition, there is no sound rendered during the reverse function to help the user. For example, if the user is interested in replaying a recent statement, the user must determine the approximate prior location of interest from the video being rendered in reverse (for example, by watching the actors). By the time the user stops the reverse function, a significant amount of extra backward movement in the video stream has often occurred. Starting the tape can also begin in the middle of a spoken sentence, again confusing and frustrating to the user. In addition, if the content is not rendered in reverse during the reverse function, the user must guess when to stop it and can have no idea of the location at which the video stream is being restarted.

The above video playback features (and their attendant disadvantages) can be found on video systems that use tape, hard drive or optical discs to generate video streams. Some systems also allow a user to replay a part of a video stream just played by pressing a “jump-back”, “repeat”, or like button. This typically stops the current play of the video stream and re-starts it from a fixed time earlier in the video stream. For example, when a user selects the jump back button (on a remote, for example), the video stream stops play, moves back 30 seconds in the video stream, and re-starts play. Thus, for a VCR application, pressing the jump-back button causes the tape to re-wind 30 seconds of play time and restarts the play function from that location. Like features are also found in hard drive and optical based video systems.

However, from the user's perspective, such a fixed amount of time has many disadvantages. A fixed amount of time will generally place the video stream back to a location that is before or after the particular moment in the video stream the user is interested in. Such an arbitrary location may be distracting, confusing, or frustrating to the user. For example, the user may have missed one word of recent dialog and does not want to replay the last 30 seconds of video. In addition, for some systems the jump-back feature discretely jumps back to the prior location without rendering the video spanning the jump back interval in reverse to the user. Thus, the user may have no idea where he or she is in relation to the location of the video stream that he or she is interested in. The user can only let the video play from that location forward, or jump back another 30 seconds, which can simply compound the problem. In addition, pressing the jump back button may present a portion of the video from a prior shot, present an incomplete portion of a previous dialog, etc. Again, this may confuse the user.

In addition, certain systems, such as hard drive and optical video systems, may allow the user to access a menu that provide chapters of the video stream. DVDs are one well-known example of this type of option. A user may thus access the menu and replay the video stream from the beginning of a previous chapter. Chapters, however, are groupings of shots that are created to present a visual narrative (or table of contents) to the user. Thus, they are a subjective grouping of shots of another party. Among other disadvantages, moving back to the beginning of a chapter does not allow the user to select the location that he or she wants to replay from. For example, if the user is only interested in a short amount of replay, such as from the time the current speaker began speaking, selecting the beginning of the current chapter may position the user in a location in the video stream long before the location of interest.

In another area of interest, techniques of video browsing are a topic of interest and development. Browsing generally focuses on aiding a user to determine if video content is of interest to the user, typically by presenting a user with some type of summary of the video contents. For example, in Li, et al., “Browsing Digital Video”, Proceedings of ACM CHI '00 (The Hague, The Netherlands, April, 2000), ACM Press, pp. 169-176, among other things, a user is presented with an index of the video comprising shot boundary frames. According to Li, the shot boundary frames may be generated by a detection algorithm which records their location in an index. When the video stream is playing, the shot boundary frame for the current shot is highlighted, and the user can select another part of the video by clicking on another shot boundary frame in the index. Because the shot boundary index is complete for the entire video, the user may move forward or backward from the current location.

Similarly, Van Houten, et al., “Video Browsing & Summarisation” (copyright 2000, Telematica Instituut (TI ref: TI/RS/2000/163)) refers to using shots as a storyboard (Section 2.3) and again references the Li publication (Section 2.4.3). Van Houten also refers to using speech recognition of dialog in indexing (Section 2.4.1).

The invention includes a method of detecting or utilizing data identifying content changes of a video stream that occurred prior to the current play position of the video stream. The content changes are comprised of breaks in speech in the video (referred to generally as a “speech break” below). A speech break in the video may be where speaking commences after a relative period of silence. Content changes may comprise other significant changes of content in the video stream, such as shot cuts in the video. A playback or replay option that the user can engage causes the video stream to move backward to the previous content change in the video stream in sequence, and then play the video stream forward from the location of the prior content change selected by the user.

Thus, in one aspect of the invention, a video stream is received and played for a user by a video display system. The video stream is also processed substantially in real time to detect speech breaks within the video stream as it plays. Locations of speech breaks in the video stream prior to the current play position of the video stream are maintained. As the video stream plays, additional speech breaks are detected and their locations in the video stream added to the memory. If the user engages the playback option, the output of the video stream stops and begins at the closest prior speech break location. Thus, unlike the replay systems in the prior art, the video is replayed from a location in the video that is coherent to the user.

The user may engage the playback option multiple times, each time causing the video stream to move back one additional speech break in the video stream. Thus, the user may move back to the beginning of a particular speech break in the video he or she is interested in replaying from. When the user stops engaging the playback option, the video stream recommences playing from the location of the selected prior speech break. Again, the user can move back in the video so that playback starts from a coherent location in the video, for example, a speech break location where a person commences speaking.

Other types of prior content changes, such as shot cuts may also be detected in the video stream. Their locations may be stored together with speech breaks detected, thus comprising an integrated list of prior change locations. Replay may be started from any of these prior change locations.

In another aspect of the invention, the change locations are pre-identified and included as part of the video stream during play by the user. As in the cases noted above, the user may engage the playback option to restart play of the video stream from a prior change location as identified in the video stream data.

In additional variations of the invention, other prior changes in the video stream are made available for playback, in addition to prior speech breaks and shot cuts. For example, changes in movement of objects and persons may be detected and used as prior locations in the video stream from which replay may begin.

Thus, in general, the invention includes a method of replaying a media stream from a previous location in the media stream, including replaying the media stream from a selected one of a number of previously identified content changes in the media stream, wherein the content changes comprise prior speech breaks in the media stream. The invention also includes a method of replaying a digital media stream from a location in the media stream prior to the current play position T of the media stream. The method includes detecting content change locations in real-time as the media stream plays. At least a number of the closest change locations detected prior to play position T are stored. One or more input signals comprising a number m are received, and the mth closest charge location prior to position T in the media stream is retrieved. The media stream is replayed from the mth closest change location to T in the media stream.

In addition, the invention includes a system that replays a media stream from a previous location in the media stream. The system includes a processor and a memory, the processor receiving one or more input signals selecting one of a number of previously identified content changes in the media stream. The processor further retrieves from memory a location corresponding to the selected content change and activates replay of the media stream from the selected change location, wherein the content changes identified comprise prior speech breaks in the media stream.

Still yet provided is a computer program product embodied in a computer-readable medium to replay a media stream from a selected prior location in the media stream, the computer program product carrying out the methods of the present invention.

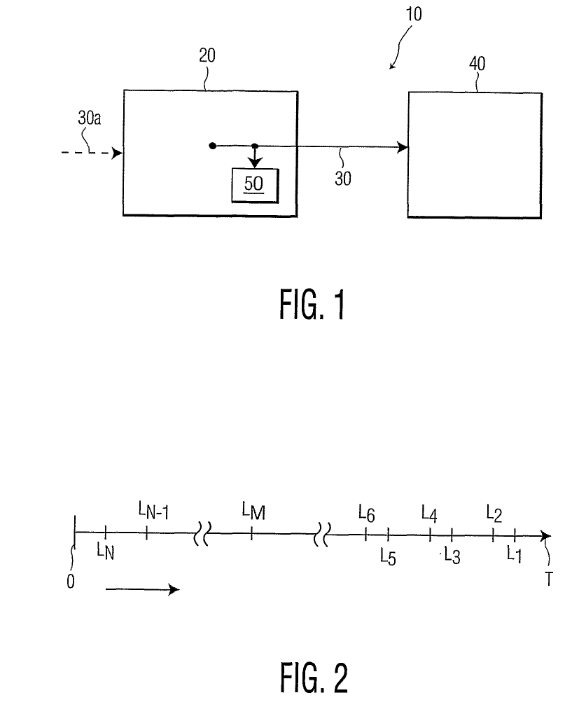

FIG. 1 is a representative diagram of a device and system that supports the present invention;

FIG. 2 is a representative drawing of prior change locations in a video stream at a play point T; and

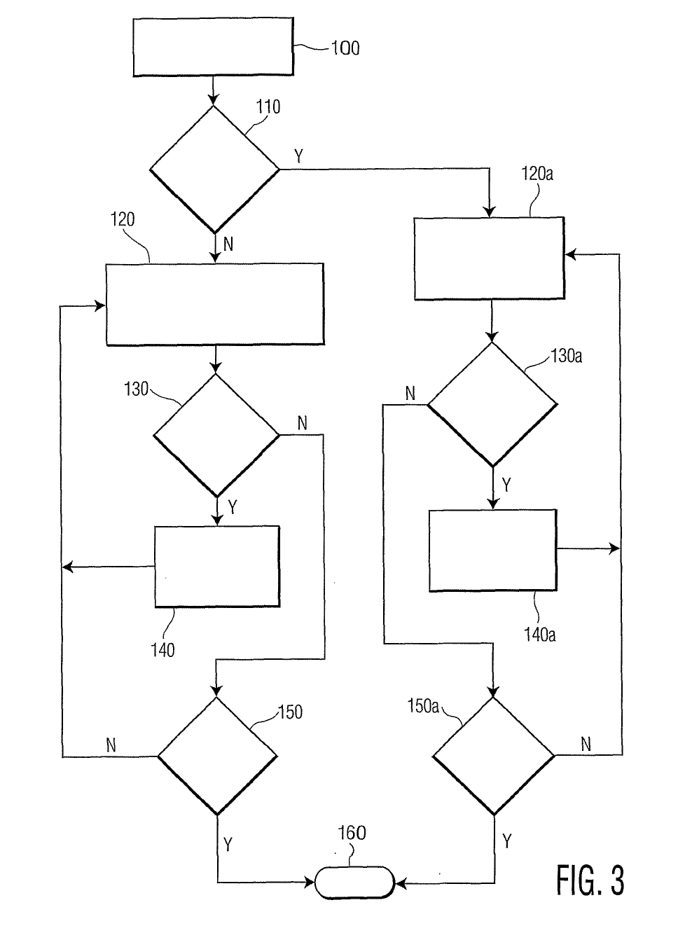

FIG. 3 is a flow chart of an embodiment of the present invention.

FIG. 1 presents a system 10 that operates in accordance with the present invention. Video device 20 generates and provides a video stream 30 that is displayed to a user via display 40. The video device 20 may be any of a number of typical devices, such as a video cassette recorder that plays a tape or a DVD player that plays a disc. Video device 20 may generate video stream 30 by playing a pre-recorded video cassette tape or DVD inserted therein. Video device 20 may also have hard drive storage for storing a video stream, in which case video stream 30 may be generated by playing a video program stored on the hard drive. Where video device 20 has a tape, hard drive, or like recording capability, device may be also be capable of receiving and recording an input video stream 30a, which is then played back as the displayed video stream 30. The input stream may be received, for example, over a wire interface (e.g., cable television broadcast, webcast from a server, etc.), or wirelessly (e.g., via a traditional over-the-air television broadcast, satellite television broadcast, or other broadcast via the air interface). In such devices, displayed video stream 30 may initially be the input video stream 30a (i.e., not a stored stream). Once a replay is initiated, the displayed stream 30 falls behind the input stream 30a and is provided from the stored stream in memory. Although device 20 is shown as separate from display 40, they may be located in the same device, such as a TV with an internal hard drive.

Video stream 30 is also subjected to real-time internal processing by processor 50. (Although processor 50 is shown as internal to device 20, processor 50 may alternatively be located external to device 20.) Processor 50 is programmed to detect speech breaks within the video stream. There are many known techniques that may be used in the present invention to detect speech breaks. For example, the received video stream 30 of FIG. 1 may be processed in an audio characterization module of processor 50 to segment audio portions thereof into categories such as speech and silence. Each frame in the video stream is generally characterized by a set of audio features such as mel-frequency cepstrum coefficients (MFCC), Fourier coefficients, fundamental frequency, bandwidth, etc. (Depending on the format of the video stream, certain pre-processing may be required to extract the audio features.) The audio features are analyzed for those that correspond to human speech parameters after a relative period of silence. Locations in the video stream where speaking commences after a relative period of silence are identified and stored by processor 50 as a speech break comprising a commencement of speech.

FIG. 2 represents the locations of speech breaks (for example, speech commencement locations) in video stream 30 identified by processor 50 as described above. T represents the current position of play in the video stream 30, while points to the left of T represent prior locations of play in the video stream. Point 0 represents the beginning of the video stream. Points L_{N}, . . . , L₁ represent the locations of N prior speech breaks in the video stream identified and stored by processor 50 through time T. (The location points L in FIG. 2 are only representations of speech break locations in the video stream; location data of a speech break actually stored in memory will generally be the time stamp, frame number, or like indicium of the break location in the video stream.) For convenience, the representative prior speech break locations L in FIG. 2 are labeled in descending order, from the oldest (L_{N}) to the most recent (L₁) with respect to current play time T. Of course, as play progresses, new speech breaks are detected after location L₁ and their locations are stored in memory. However, FIG. 2 is generally representative of N total prior change locations that are detected and stored through any given time T of the video stream.

Thus, L_{N} represents the first speech break location in the video stream, and L₁ represents the most recent speech break location in video stream 30 through play time T. Thus, if a person is speaking at time T, location L₁ represents the closest (or most recent) prior speech break location with respect to the current play position T in the video stream. Prior location L₂ is the second closest prior location in the video stream at which a person began speaking, etc.

Video device 20 includes a playback or replay feature. When the replay feature is engaged at time T, device 20 accesses the prior speech break locations stored by processor 50 and retrieves the closest prior speech break location L₁. Playback device 20 stops the current output of the video stream, and begins replay from location L₁. By replaying from location L₁, replay starts from the most recent coherent point in the video stream, that is, when the most recent speaker in the video stream began speaking. By engaging the replay feature two times, replay starts from the second prior speech break location L₂. By engaging the replay feature a number of times “m” in succession, device 20 retrieves the location of the mth closest prior speech break Lₘ to T in the video stream, and begins replay of the video stream from that location.

Thus, for example, if device 20 is a VCR, the stored locations of the identified prior speech breaks maybe the time stamps of the frames in the video stream. Device 20 rewinds the tape to the time stamp of the prior speech break selected. If device 20 is a DVD, for example, and the prior speech breaks identified are stored by tracking data, device 20 moves the laser to the track position of the prior speech break selected and continues play. If device 20 is a hard drive based system, then prior speech breaks may be identified by the memory address for the corresponding frame of the stored video stream. When the replay command is received, the video stream 30 is output beginning at the memory address for the selected prior speech break.

The replay feature may be engaged manually, for example, by pressing a button on video device 20, or alternatively by pressing a button on a remote (not shown) that sends an appropriate IR signal to device 20. Alternatively, the replay feature may be engaged by voice activation or gesture recognition or other suitable command input. For example, for speech recognition, the replay feature may be engaged and move back one speech break for every time the user speaks the word “replay”. Gesture recognition of a user may be detected by device 20 using an external camera that captures the user's movements; the captured images may be processed in a subroutine by processor 50 using well-known image detection algorithms to detect an input gesture. (For example, gesture recognition may utilize radial basis function techniques as described below for detecting movement in the video stream.) Similarly, voice activation may utilize an external speaker attached to device 20 that captures the user's voice and supplies it to processor 50, which analyzes it for command words using well-known voice recognition processing. (For example, the voice recognition may analyze audio features (such as those described above for detecting speech breaks in the video stream 30) to identify particular spoken words corresponding to commands).

Device 20 preferably renders the content of the video stream on display 40 in reverse as it moves from the current position in the video stream to the location of the prior speech break selected. (Such is a standard feature of VCR and DVD manual reverse functions.) This provides the user with a visual frame of reference regarding how far back in the video stream the user has moved. In addition, when the replay feature is engaged, and the video stream is returned to the selected prior speech break, the play feature may not be immediately re-engaged. Instead, the video output on the display may “freeze” on the first frame of the speech break, thus allowing the user to determine visually if this is the desired replay location. If so, the user can press the play button, and the video stream output recommences. If not, the user can press the replay button again. In addition, once the user has moved backward to at least one prior change location, in this case a speech break, device 20 may have a “move forward” feature that, when pressed, moves to the next speech break forward in the video stream. Thus, if the user moves back too far using the replay button, he or she can move forward to the desired position.

In addition, processor 50 need not maintain all of the locations of speech breaks (or other content change locations) prior to the current play point. A user normally will not replay from a change location that is substantially prior in time to the current play position. Thus, processor 50 may only store the last 10 change locations (L₁₀-L₁ in FIG. 2), for example, with respect to the current play point of the video stream. As a new change location is detected in the video stream and added to the memory locations, the oldest change location (i.e., the tenth closest one in the above example) is dropped.

In the particular embodiment described above, speech breaks are detected and compiled concurrently with playing of the video stream. Alternatively, the video stream may be pre-processed such that the stream input to or generated by device 20 identifies the speech break locations. Thus, for example, where device 20 is a VCR, the video tape may include a data field that identifies speech breaks in the video stream as the video stream plays. Device 20 may thus store the location of speech breaks in a buffer memory when identified in the video stream, and utilize the locations in the replay function as described above. Alternatively, when the replay function is engaged, device 20 may detect the locations of prior speech breaks from the data field as the tape rewinds. T hus, the tape may be rewound by a selected number of speech breaks. In another variation, the speech break locations can be included at the beginning of the tape as a set of data. The data set is downloaded from the tape to device 20 prior to output of the video stream and used during the replay function to identify the locations of speech breaks prior to the current location in the video stream. Although a VCR embodiment has been focused on here, like variations apply to other types of video devices.

FIG. 3 provides a flowchart of the steps and processing undertaken in an embodiment of the invention. In step 100, a video stream is received or generated. In step 110, it is determined whether the video stream received or generated includes data that pre-identifies speech breaks. If not, then the video stream is processed and speech breaks are detected and the locations of speech breaks in the video stream are stored in real time (i.e., as the video stream is played) (step 120). As the video stream is output, the processing monitors whether the replay feature is engaged (step 130). If so, the video stream is replayed from the location of the closest prior speech break (L₁), or, if the replay feature is engaged m times, from the location of the mth closest prior speech break (Lₘ) (step 140). (The number of times m that the replay feature may be engaged is any integer 1, 2, . . . less than or equal to the number of stored speech break locations.) The processing returns to step 120, where the video stream output and detection of speech breaks continues. (In this case, speech break detection can be delayed until the video stream passes the point from which it was previously replayed, since those breaks have already been detected and stored.) If the replay feature is not engaged in step 130, it is determined whether the video stream is finished in step 150. If so, the processing ends (step 160). If not, the processing also returns to step 120.

If the speech break data is pre-identified in the video data stream in step 110, then the video stream is output in step 120a. As the video stream is output, the processing monitors whether the replay feature is engaged (step 130a). If so, the video stream is replayed from the location of the closest prior speech break, or, if the replay feature is engaged m times, from the location of the mth closest prior speech break (step 140a). This utilizes the speech break locations included in the video stream in step 120a. The processing then returns to step 120a, where the video stream output continues. If the replay feature is not engaged in step 130a, it is determined whether the video stream is finished in step 150a. If so, the processing ends (step 160). If not, the processing also returns to step 120a.

The devices, systems and methods described above focus on speech breaks as being the replay point. By replaying from a prior speech break with respect to the current play position (T) of the video stream, the video stream replays from a natural audio content change location, thus providing a coherent prior segment of audio and video to the user. Other replay locations may provide such coherence to the user and may also be included as replay locations in the processing of the invention. Other such significant content changes in the video stream that can provide coherent replay locations include scene changes or shot cuts. For example, a user may have been temporarily distracted and want to return to the beginning of the current scene. Thus, processor 50 of device 20 of FIG. 1 may also detect and store locations of shot cuts in the video stream. Although in many cases one of the speech breaks will approximately coincide with a shot cut, having both types of change locations available as replay points gives the user added flexibility.

For example, the video stream 30 of FIG. 1 may be further processed by processor 50 to detect shot cuts in the video stream. The terms “scene cuts” and “shot cuts” refer to similar concepts and will be used interchangeably hereinafter. A scene cut or shot cut typically refers to a substantial change in the video content between consecutive frames. (More generally, it refers to a substantial change of video content over a small number of frames such that the video stream appears to have undergone a discrete change in video content.) In other words, consecutive frames that are highly uncorrelated represent a scene or shot cut. The term “shot cut” will be used below, but is not intended to be limiting.

A typical shot cut comprises a change from one setting (location) to another. A shot cut can also include a change in time, even though a location remains the same. For example, an outdoor shot cut may comprise a sudden change from daylight to nighttime without a change in location, since there is a substantial change in content in consecutive video frames. Another related example of shot cuts use the same location, but comprise a change of view of the location. A well-known example of shot cuts occur in music videos, where the performer can be shown from a number of different perspectives in rapid succession.

Video stream 30 is thus also subjected to real-time internal processing by processor 50 to detect shot cuts within the video stream. There are many known techniques available that analyze video streams and detect shot cuts which may be used in the present invention. Various techniques that may be used in the present invention provide for detection of shot cuts as the video is playing in real time. For example, a number of techniques generally rely on identifying shot cuts in a video stream by analyzing the Discrete Cosine Transformation (DCT) coefficients between successive frames. Where the video stream is compressed according to MPEG standards, for example, the DCT coefficients can be extracted as the video stream is being decoded (i.e., in real time). Generally, DCT values for a number of macroblocks of pixels of a frame are determined and compared for successive frames according to one of a number of available comparison algorithms. When the difference in DCT values between frames exceeds a threshold according to the particular algorithm, a shot cut is indicated. If the video stream is not MPEG encoded, a fast DCT transform may be applied to macroblocks of the frames received, thus allowing such real-time processing for shot cut detection. An example of such a technique is described in N. Dimitrova, T. McGee & H. Elenbaas, “Video Keyframe Extraction and Filtering: A Keyframe Is Not A Keyframe To Everyone”, Proc. Of The Sixth Int'l Conference On Information And Knowledge Management (ACM CIKM '97), Las Vegas, Nev. (Nov. 10-14, 1997), ACM 1997, pp. 113-120, the contents of which are hereby incorporated by reference herein. (See, e.g., section 2.1, “Video Cut Detection”.)

Thus, processor 50 uses at least one such technique to identify shot cuts in the video stream 30 in real time. The identified shot cut locations in the video stream are stored in sequence together with the speech break locations, as previously described. The locations in the video stream may be identified by frame number, time stamp, or the like. Thus, referring back to FIG. 2, in this case L_{N}-L₁ depicted show the locations of N prior “content changes” (either speech breaks or shot cuts) of the video stream up to the current play point T. For example, the last change location L₁ may represent the location in the video stream at which the actor currently speaking at time T began to speak. L₂-L₅ may represent like prior speech break locations in the stream, L₆ may represent the last shot cut location, etc. When the user engages the replay function, the video stream is replayed from the last change location, in this case L₁. Thus, if the user misses a word of the current speaker, for example, pressing the replay feature once commences the video stream at the point the current speaker began to speak.

Similarly, engaging the replay function twice replays the video stream from the next prior speech break L₂. (The next prior speech break may be a speech commencement of a different speaker. It may also be another speech commencement for the current speaker at time T, if the speaker pauses significantly between speech commencement locations L₁ and L₂.) Pressing the replay function m times replays the video stream from the mth prior change location. Preferably, the video stream is rendered in reverse as the replay feature is engaged. This allows the user to identify a particular change of interest (such as the last shot cut, which may be point L₆, for example) and allow forward play to recommence.

It is noted that all change locations, including shot cut locations and speech break locations (such as locations where speaking commences after a relative silence), may also be pre-identified in the data stream. Thus, as described above, processor 50 may utilize the locations of changes as pre-identified in the video stream during the replay function. In addition, FIG. 3 may represent the processing steps used where both shot cuts and speech breaks are detected and stored in an integrated fashion in memory by processor 50. Thus, for each of the steps depicted in FIG. 3, the focus on “speech breaks” can be generalized to “content changes”, comprised of, for example, both speech breaks and shot cuts.

As noted above, shot cuts can be detected in a number of ways, for example, by monitoring changes in the DCT coefficients for macroblocks of successive frames to detect a substantial change between frames. However, certain changes can also occur within a same shot that are less substantial, but may nonetheless be an important change point to the user. For example, an actor (or object) that begins to move within a shot may be a change of interest to a user. Similarly, another actor being added to the shot (e.g., by walking into the shot through a door) may also be a change of interest. Such changes are similar to an actor beginning to speak after a relative period of silence discussed above. They might be a change of interest to a user, but occur within a shot. Thus, changes of movement of an actor (or object) within a scene may comprise a significant content change for the purpose of the invention.

Accordingly, replaying from the location of the beginning of such changes of motion can provide replay coherence to the user and may also be included as replay locations in the processing of the invention. Thus, for example, the user may want to return to a recent point in the video stream where an actor in the scene began walking toward a door. Accordingly, processor 50 of device 20 of FIG. 1 may also identify persons or objects within a scene and store locations in the video stream where a person or object begins to move after being stationary.

For example, the video stream 30 of FIG. 1 may be further processed in processor 50 to identify human contours and/or human faces within the shot and detect their movement between frames. There are many methods and techniques of real-time image recognition and motion detection available in the art that may be programmed in processor 50 for this purpose. For example, techniques that may be used to identify humans moving in the video stream are described in commonly-owned and co-pending U.S. patent application Ser. No. 09/794,443, filed Feb. 27, 2001, entitled “Classification Of Objects Through Model Ensembles” by Gutta, et al., the contents of which are hereby incorporated by reference herein. (It is also noted that U.S. patent application Ser. No. 09/794,443 corresponds to WIPO Published PCT Application having International Publication No. WO 02/069267 A2.) Locations in the video stream where a person begins to move after being stationary are thus identified and stored by processor 50.

The locations corresponding to such commencement of movement of a person in the video stream are integrated with the locations of the detected shot cuts and speech breaks in storage, in the same manner as previously described. Thus, each stored change location represented in FIG. 2 would be a prior location for a commencement of speaking, a commencement of movement, or a shot cut in the video stream. For example, L₁ may represent the location of an actor in the current shot beginning to reach for an object, L₂ may represent the location of a beginning of speaking by the actor currently speaking in the shot, L₃ may represent the last shot cut, etc. When the user engages the replay function, the video stream is replayed from L₁, the closest prior change location with respect to the current play location T. This commences the video stream at the point the actor begins to reach for the object. Pressing replay again replays the video stream from L₂, the beginning of speaking by the current actor, etc.

Various users may have certain replay propensities that the system and device of the invention may utilize to customize the replay function. For example, if a particular family of one or more users typically uses the replay function to move back to the last shot cut location in the video stream, then device 20 may set the most recent prior shot cut as the default replay location. Device 20 may include a learning algorithm that monitors the replay inputs over time and adjusts the replay function to reflect the collective preferences of the one or more users of the system. These may change over time. In like manner, the system and device may customize the replay function for different individual users who use the system and device. In that case, the device 20 will have an identification process for each user (such as a login procedure) and monitor and store the propensities of the various users. In addition, the stored change locations for the video stream would also include a change type (shot cut, speech, movement, etc), so that the replay could skip those intervening change locations that do not correspond to the current user's preference. Such preference-based replays could be initiated by a different input (e.g., a “Repeat-2” input) while leaving the original replay feature to allow the user to move back in sequence through all locations.

Also, where the locations L_{N}-L₁ are comprised of different content changes (shot cuts, speech breaks, etc.), different replay functions can be engaged for playback from each type of change. In that case, processor 50 stores a change type with the change location.

In addition, referring back to FIG. 1, device 20 may alternatively be located at a service provider that provides video stream 30 over a wire or air interface to user's display device 40. Device 20 processes the video stream to determine or detect change locations in the video stream in the manner as described above. When the user engages the replay feature, it is transmitted to service provider, which replays the video stream from the prior change point location as also described above.

In addition, in the above exemplary embodiments, one movement back to a prior change point in the video stream was done by a separate engagement of the replay feature. Thus, for example, to move back “m” change locations in the video stream, the playback option was described as being engaged “m” times. Other ways of engaging the replay feature are possible and encompassed by the invention. For example, one control input may cause the replay feature to move back “m” change locations. For example, where the input is via a remote, the channel number “5” may be pressed on the remote to cause the replay feature to move back 5 change locations in the video stream. Alternatively, where the input is via gesture recognition, holding up 3 fingers may cause the replay feature to move back 3 change locations in the video stream.

In addition, the content changes exemplified above are not intended to be limiting. The invention encompasses any type of significant content change that may be detected (or pre-identified) and used as a replay location. For example, in the above embodiments speech breaks comprising speech commencement and changes in motion comprising motion commencement were exemplified. Alternatively (or in addition), speech and motion termination can be used as content change points. Other content changes, such as color balance, audio volume, music commencement and termination, etc., can also be used.

In addition, while the above exemplary embodiments of the invention focus on a video stream (having an audio component), the invention is not limited to media streams that include a video component. Thus, the invention encompasses other media streams. For example, the invention also includes like processing of an audio stream alone. In this context, an audio stream may be generated from by a tape player, a CD player or a hard drive based device, for example. (Initially, prior to a user initiating the replay function, an external audio stream may be received and output in real-time by device, while simultaneously being recorded. Once the replay feature is initiated, the audio stream falls behind the received stream and is thus generated from the storage medium.) Processing of the audio stream to detect and store prior speech breaks included in the audio stream proceeds in like manner as in the processing of a video stream described above. When the user engages the replay feature, for example, the audio stream is stopped and replayed from a prior speech break determined according to the input received from the user by the replay feature.

While the invention has been described with reference to several embodiments, it will be understood by those skilled in the art that the invention is not limited to the specific forms shown and described. Thus, various changes in form and details may be made therein without departing from the spirit and scope of the invention as defined by the appended claims. For example, as noted above, there are many techniques that may be used in the present invention for detecting speech breaks, detecting shot cuts, image recognition and motion detection. Thus, the particular techniques described above relating to detecting speech breaks, detecting shot cuts, image recognition and motion detection are by way of example only and not to limit the scope of the invention.

1) A method of replaying a media stream (30) from a previous location (L_{N}-L₁) in the media stream (30), the method comprising replaying the media stream (140, 140a) from a selected one of a number of previously identified content changes (120, 120a) in the media stream (30), the content changes comprising prior speech breaks in the media stream (30).

2) The method of claim 1, wherein the media stream (30) is a video stream (30) and the previously identified content changes (120, 120a) further comprise at least one of shot cuts and changes of motion.

3) The method of claim 1, wherein the prior speech breaks comprise commencement of speech after a relative period of silence in the media stream (30).

4) The method of claim 1, further comprising receiving a control command (130, 130a) used to select the one previous content change in the media stream (30) from which to replay (140, 140a).

5) The method of claim 4, wherein the control command (130, 130a) comprises a number m of input signals, the m input signals used to select the mth previous content change in the media stream from which to commence replay (140, 140a).

6) The method of claim 4, wherein the control command (130, 130a) used to select the one content change from which to replay (140, 140a) is processed based on prior control commands received.

7) The method of claim 4, wherein the control command received (130, 130a) is generated by at least one of a manual input, a voice input and a gesture recognition.

8) The method of claim 1, further comprising identifying and storing the locations of the prior content changes in real time (120) while the media stream (30) is playing, the replaying of the media stream from the selected prior content change (140) utilizing the stored location corresponding to the selected content change.

9) The method of claim 1, further comprising identifying the locations of prior content changes in the media stream from data included in the media stream (120a), the replaying of the media stream from the selected prior content change (140a) utilizing the location of the selected content change included in the media stream (30).

10) The method of claim 1, further comprising generating the media stream (100) from at least one of a magnetic tape, an optical disc, a server and a hard drive.

11) The method of claim 1, further comprising receiving the media stream (100) from an external source.

12) The method of claim 11, further comprising recording the received media stream and replaying from the recorded media stream.

13) The method of claim 1, wherein the replaying of the media stream (140, 140a) from a selected one of a number of previously identified content changes (120, 120a) in the media stream (30) is a function of the type of content change.

14) A method of replaying a digital media stream (30) from a location in the media stream prior to the current play position T of the media stream (30), the method comprising the steps of:
a) detecting content change locations (L_{N}-L₁) in real-time as the media stream plays (120);
b) storing at least a number of the closest change locations detected prior to play position T (120);
c) receiving one or more input signals comprising a number m (130);
d) retrieving from memory the mth closest change location prior to position T in the media stream; and
e) replaying the media stream from the mth closest change location to T in the media stream (140).

15) The method of claim 14, wherein the media stream (30) is at least one of an audio stream and a video stream.

16) The method of claim 15, wherein the change locations are comprised of speech break locations in the media stream.

17) The method of claim 16, wherein the media stream (30) is a video stream and the change locations are further comprised of at least one of shot cut locations and change of motion locations.

18) A system (10) that replays a media stream (30) from a previous location (L_{N}-L₁) in the media stream (30), the system (10) having a processor (50) and a memory, the processor (50) receiving one or more input signals selecting one of a number of previously identified content changes in the media stream (30), the processor (50) further retrieving from memory a location (L_{N}-L₁) corresponding to the selected content change and activating replay of the media stream (30) from the selected change location (L_{N}-L₁), wherein the content changes identified comprise prior speech breaks in the media stream (30).

19) The system (10) as in claim 18, wherein the processor (50) further identifies the content changes in the media stream (30) and stores their locations (L_{N}-L₁) as the media stream (30) plays.

20) The system (10) as in claim 18, wherein the system (10) further generates the media stream (30).

21) The system (10) as in claim 18, wherein the system (10) further receives the media stream (30) and records the media stream (30).

22) The system (10) as in claim 18, wherein the system (10) is comprised of a single device (20) that houses the processor (50) and memory, receives the input signals, and activates the replay.

23) The system (10) as in claim 22, wherein the device (20) is one of a VCR, a CD player, a DVD player, and a PC.

24) A computer program product embodied in a computer-readable medium to replay a media stream (30) from a selected prior location (L_{N}-L₁) in the media stream (30), the computer program product comprising:
a) computer readable program code that detects content changes in real time as the media stream plays (120);
b) computer readable program code that stores in a memory at least a number of the locations (L_{N}-L₁) of the closest content changes in the media stream detected prior to play position T (120);
c) computer readable program code that receives one or more input signals comprising a number m (130);
d) computer readable program code that retrieves from memory the mth closest change location prior to position T in the media stream; and
e) computer readable program code that generates an output signal to replay the media stream from the mth closest change location prior to T (140).
